(19) United States
(12) Patent Application Publication
(10) Pub. No.: US 2022/0048679 A1
(43) Pub. Date: Feb. 17, 2022

(54) RECLOSABLE PACKAGE AND METHOD AND MACHINE FOR MANUFACTURING A RECLOSABLE PACKAGE

(71) Applicant: MULTIVAC SEPP HAGGENMUELLER SE & CO. KG, Wolfertschwenden (DE)

(72) Inventor: Christian UEBELE, Parkville, MO (US)

(73) Assignee: MULTIVAC SEPP HAGGENMUELLER SE & CO. KG, Wolfertschwenden (DE)

(21) Appl. No.: 16/993,416

(22) Filed: Aug. 14, 2020

(51) Int. Cl. B65D 33/25; B65D 75/32; B65B 61/18; B65B 9/04

(52) U.S. Cl. CPC B65D 33/2516; B65D 75/326; B65D 2575/3254; B65B 9/04; B65B 61/188

(57) ABSTRACT

A reclosable package may comprise a first web thermoformed into a trough shape and a second web that encloses a product cavity with the first web. A first sealing extends over at least a portion of the first web and the second web and connects the first web and the second web. The first sealing at least partially defines a periphery of the product cavity. The package further includes a zipper element comprising a third web, a fourth web and a zipper track that is arranged at an outer border of the third web and the fourth web. The zipper element extends from an overlapping region of the first web and the second web, and the zipper track is arranged outside of the overlapping region. Furthermore, in the overlapping region, the third web is fused with the first web and the fourth web is fused with the second web.

### TECHNICAL FIELD

The disclosure concerns a reclosable package, a method for manufacturing a reclosable package and a machine for manufacturing a reclosable package.

### BACKGROUND

In packaging industries, it is common practice to provide products in packages that comprise a product cavity, where the packages are sealed so as to keep the products fresh until the first opening.

EP 1 388 410 A1 describes a method and an apparatus for producing zippered bags at faster speeds. The ultrasonic welding operation performs an ultrasonic welding continuously while the web of bag making film and the zipper tape are moving. To facilitate this, the ultrasonic welding station is moved from the bag making machine, where the bag making film and zipper tape move intermittently, to a sealer frame, where the film and zipper tape move continuously. The ultrasonic welding apparatus comprises a pair of rotary elements one of which is acoustically coupled to an ultrasonic transducer. One of the rotary elements is provided with a protuberance on its periphery that acoustically couples the zipper tape to the energized rotary element to cause welding.

Further, US 2005/124479 A1 discusses methods and apparatus for controlling the tension of one continuous material (e.g., plastic zipper) with attachments or formed features (e.g., sliders or formed slider end stops) as it is fed to a sealing station, where it is joined to and later pulled by another continuous material (e.g., packaging film). The tension control scheme can be applied in cases wherein the packaging film advances a single package length per advancement as well as cases wherein the packaging film advances a distance equal to multiple package lengths per advancement. A tension control zone is created between a pair of nip rollers disposed in zipper processing equipment and a zipper sealing station inside a thermoforming packaging machine by applying a predetermined torque to one of the nip rollers using a torque control device. The zipper processing equipment may comprise a zipper shaping station and a slider insertion station. The torque control device applies a substantially constant torque that maintains the zipper tension substantially constant in the tension control zone, especially during zipper stomping, slider insertion and zipper sealing.

Additionally, US 2005/039418 A1 discloses methods and apparatus for controlling the registration of one elongated continuous structure (e.g., plastic zipper) with attachments or formed features (e.g., sliders or pre-seals) as it is fed to a sealing station, where it is joined to another elongated continuous structure (e.g., packaging film) with formed features (e.g., thermoformed pockets). The latter elongated continuous structure will be intermittently advanced through the machine, pulling the former elongated continuous structure joined thereto forward. Registration is accomplished by tacking the respective elongated continuous structures together while the respective features on the elongated continuous structures are in proper registration. After tacking, the respective portions of the elongated continuous structures immediately downstream of the tack zone are advanced to the sealing station in proper registration.

U.S. Pat. No. 5,246,720 discloses a reclosable package consisting of an inner peripheral seal around a product cavity within which the products are disposed, and an outer seal around the inner seal. The area inside the inner seal, containing the product, is preferably evacuated. The outer seal is defined in part by a reclosable assembly which, after breaking of the inner seal, provides access to the interior of the package and reclosability of the package. A method of constructing a package and of packaging a product are also disclosed.

While the above described packages are reclosable, their handling by a user is difficult and further, also manufacturing is complicated as the zipper element has to be properly placed in a constant stream of webs.

### SUMMARY

Starting from the known prior art, a technical problem to be addressed is to provide a reclosable package and a method as well as a machine for producing a reclosable package that can easily be handled by a user and can be obtained with simplified means of production.

This problem may be solved by a reclosable package according to the disclosure, a method of manufacturing a reclosable package according to the disclosure and a machine for producing a reclosable package according to the disclosure.

In one embodiment, a reclosable package, comprises:

a first web thermoformed into a trough shape and a second web, the first web and the second web enclosing a product cavity;

a first sealing extending over at least a portion of the first web and at least a portion of the second web and connecting the first web and the second web, the first sealing at least partially defining a periphery of the product cavity;

a zipper element, the zipper element comprising a third web, a fourth web, a zipper track and an optional slider for opening and closing the zipper track;

the zipper track and the optional slider being arranged at an outer border of the third web and the fourth web;

the zipper element extending from an overlapping region of the first web and the second web, wherein the zipper track and the optional slider are arranged outside of the overlapping region;

wherein, in the overlapping region, the third web is fused with the first web and the fourth web is fused with the second web.

By having the zipper element provided so as to extend outside the first and second web, the zipper element can be opened and closed more easily, allowing easier and simplified access to the product within the reclosable package.

The slider is only optionally provided to close and open the zipper track. Provision of the slider may depend on how the zipper track is actually provided. In case it is provided in the form of two interlocking members that can be separated and brought together without the need of a slider, the slider may not be present. The disclosure is thus not meant to be limited in this regard. Any embodiment which refers to a slider may therefore also be implemented without a slider.

It is possible that the third web and the fourth web have a polyethylene coating on their outer surface at least in the overlapping region. In this context, the polyethylene coating on the outer surface may be considered as a polyethylene coating on the surface of the third web that immediately faces the first web and on the surface of the fourth web that immediately faces the second web. Thereby, a reliable fusing of the third web with the first web and the fourth web with the second web can be achieved without the third web and the fourth web fusing with each other during the manufacture of the reclosable package. This ensures the accessibility of the product cavity of the reclosable package.

In an embodiment, the third web and the fourth web are fused together at border regions of the third web and the fourth web extending from the zipper track to the overlapping region. Thereby, also the border regions are sealed tightly in order to ensure that the product cavity is completely isolated from the environment when the zipper element is closed. Thereby, the products in the product cavity can be kept particularly fresh.

More specifically, the border regions, the first sealing and the zipper element may define the periphery of the product cavity. This means that, in one embodiment, there is no further sealing between the product cavity and the zipper element, so that when the zipper element, specifically the zipper track is opened with the aid of a slider, the product cavity is immediately accessible without having to break an inner seal in this region. Producing the reclosable package as well as accessibility of the product cavity is thereby improved.

The reclosable package can comprise a second sealing between the third web and the fourth web in the overlapping region, the first sealing and the second sealing together defining the periphery of the product cavity. With this configuration, an “inner sealing” is provided that encloses, together with the first sealing, the product cavity from the environment even in case the zipper element is, for example, accidentally opened. This may be a breakable seal, allowing for accessing the product cavity. Furthermore, the product cavity may be accessed without damaging the first web and the second web.

In an embodiment, the zipper track and the optional slider are arranged outside of the first web and the second web and outside of the overlapping region. With this embodiment, the accessibility of the zipper element and specifically the optional slider (if present) at the zipper track is made easier for the user. The arrangement of the zipper track and the optional slider outside of the first web and the second web as well as outside of the overlapping region specifically means that, when seen from above the reclosable package and from below the reclosable package, the zipper track and the optional slider are not covered by the first web and the second web or the overlapping region.

Further, a method for manufacturing a reclosable package is provided, the method comprising the steps of:

providing a first web and a second web;

forming a product cavity by the first web and the second web;

arranging, between the first web and the second web, a zipper element, the zipper element comprising a third web, a fourth web, a zipper track and an optional slider for opening and closing the zipper track, the zipper track and the optional slider being arranged at an outer border of the third web and the fourth web; wherein the zipper element is arranged between the first web and the second web so as to extend from an overlapping region of the first web and the second web to a region outside of the overlapping region, wherein the zipper track and the optional slider are arranged outside of the overlapping region;

forming a first sealing by fusing together at least a portion of the first web and a portion of the second web;

fusing together, in the overlapping region, a portion of each of the third web and the first web and a portion of each of the fourth web and the second web.

This method provides a simplified manufacture of a reclosable package having a zipper element that can be opened and closed at will.

Further, forming the product cavity may comprise forming a product cavity in the first web by thermoforming. By thermoforming, product cavities can be formed, for example, from plastic materials in a reliable manner.

In an embodiment, one of the first web and the second web comprises an extending region that extends, in the direction from the overlapping region to the zipper track, beyond the position of the zipper track and the optional slider;

wherein the method further comprises lifting the zipper element by lifting the optional slider and/or the zipper track away from the extending region;

cutting the extending region away while the zipper element is lifted.

Providing the extending region in the first place results in a support or base being provided when placing the zipper element, so that misalignments between the first web, the second web and the zipper element can be avoided while the zipper element is not yet fixed to the first and second webs. As the zipper element extends outwards of the overlapping region, it can be reliably lifted with corresponding means and the extending region can be cut away without the risk of causing damage to the zipper element, thereby avoiding damage to the reclosable package.

It may be provided that, before forming the first sealing and after forming the product cavity, the method comprises placing a product in the product cavity. With this, products can be readily placed in the product cavity and the sealing of the product cavity can take place immediately afterwards, thereby ensuring that the products stay fresh.

Moreover, the first web and the second web and the zipper element may be provided as endless elements and may be transported on at least one chain, wherein at least one of the first web and the second web may comprise a print element, and the first web and the second web are registered relative to each other and the product cavity depending on the position of the print element. Thereby, an alignment of already provided print elements with product cavities is ensured.

In a further aspect, a machine for producing a reclosable package is provided, the machine comprising a transport track for registered transport of a first web and a second web, a forming station for forming a product cavity in the first web or the second web, a zipper supply station for providing, in an overlapping region of the first web and the second web, a zipper element, the zipper element comprising a third web, a fourth web, a zipper track and an optional slider for opening and closing the zipper track, wherein the zipper supply station is configured to arrange the zipper element so as to extend from the overlapping region of the first web and the second web to a region outside of the overlapping region, and so that the zipper track and the optional slider are arranged at an outer border of the third web and the fourth web and outside of the overlapping region;

wherein one of the first web and the second web comprises an extending region that extends, in the direction from the overlapping region to the zipper track, beyond the position of the zipper track and the optional slider when the zipper element is arranged by the zipper supply station;

the machine comprising a lifting element for lifting the zipper element by lifting the optional slider and/or the zipper track away from the extending region, a cutter element for cutting away the extending region while the zipper element is lifted;

the machine comprising a first sealing station for sealing the first web and the second web so as to form a first sealing defining at least a portion of a periphery of the product cavity and a second sealing station for sealing a portion of each of the third web and the first web and a portion of each of the fourth web and the second web in the overlapping region.

This machine allows the production of an easier to handle reclosable package while the production is simplified due to the provision of the lifting element aiding in cutting away the extending region without damage to the reclosable package.

A third sealing station may be provided for sealing the third web and the fourth web at the border regions of the third web and the fourth web, the border regions extending from the zipper track to the overlapping region. With this third sealing station, a subsequent sealing of the zipper element at the border regions is realized, allowing for a more flexible placement of the zipper element while it is not yet sealed at the border regions.

The machine can comprise at least one chain for transporting the first web and/or the second web. This chain provides a reliable support for the first web and/or the second web, and thereby allows for reliable alignment of the components to be fused together when manufacturing the reclosable package.

The lifting element may be arranged alongside the chain and can be adapted for moving the optional slider and/or the zipper track in the direction of a center line of the chain, thereby lifting the zipper element. With this arrangement of the lifting element alongside the chain, a determined alignment of the lifting element on the one side and the chain on the other side, and thus of the lifting element relative to the zipper element is achieved, allowing for a reliable and reproducible lifting of the zipper element.

The lifting element may be provided as or may comprise a plow mechanism. Such a plow mechanism, in some embodiments, may be provided as a mechanical structure that achieves the lifting of the zipper element. Thereby, a reliable and reproducible lifting of the zipper element is achieved resulting in less failures occurring during the manufacture.

More specifically, the plow mechanism may be movably arranged. A movable plow mechanism can also allow for controlling the lifting only in situations (cutting away the extending regions) and positions where this is necessary. Thereby, not the complete zipper element flow needs to be lifted.

Alternatively, the lifting element may be provided as or may comprise a stationary guide for guiding a movement of the zipper track and/or the slider, thereby lifting the zipper element. Such a stationary guide (or stationary plow) is less prone to failure, as it does not comprise driven or moved components. This increases the reliability of the machine.

While exemplary embodiments are illustrated and disclosed, such disclosure should not be construed to limit the claims. Furthermore, it is not intended that the disclosed embodiments describe all possible forms according to the disclosure. In that regard, the words used in the specification are words of description rather than limitation, and it is understood that various changes may be made without departing from the scope of the disclosure.

### BRIEF DESCRIPTION OF THE DRAWINGS

FIGS. 1A to 1C show one reclosable package according to an embodiment;

FIGS. 2A to 2B show different embodiments of a machine for manufacturing a reclosable package; and

FIGS. 3A to 3B show a method for manufacturing the reclosable package.

### DETAILED DESCRIPTION

As required, detailed embodiments are disclosed herein; however, it is to be understood that the disclosed embodiments are merely exemplary and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art. Furthermore, as those of ordinary skill in the art will understand, various features of the embodiments illustrated and described with reference to any one of the Figures may be combined with features illustrated in one or more other Figures to produce embodiments that are not explicitly illustrated or described. In addition, other embodiments may be practiced without one or more of the specific features explained in the following description.

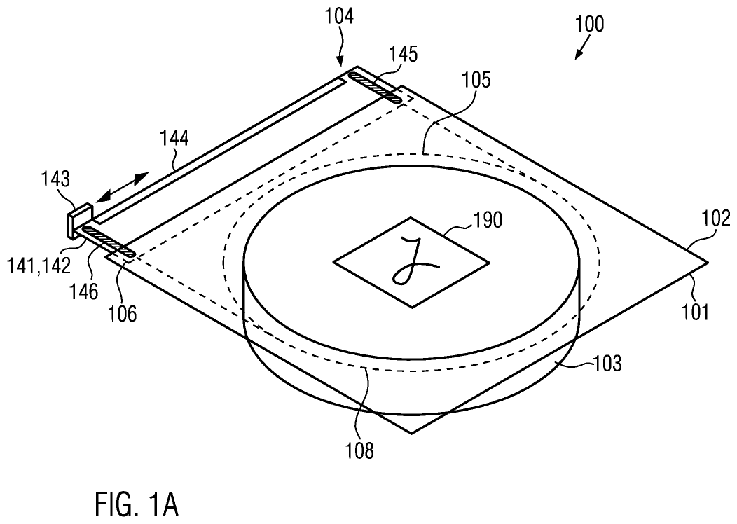

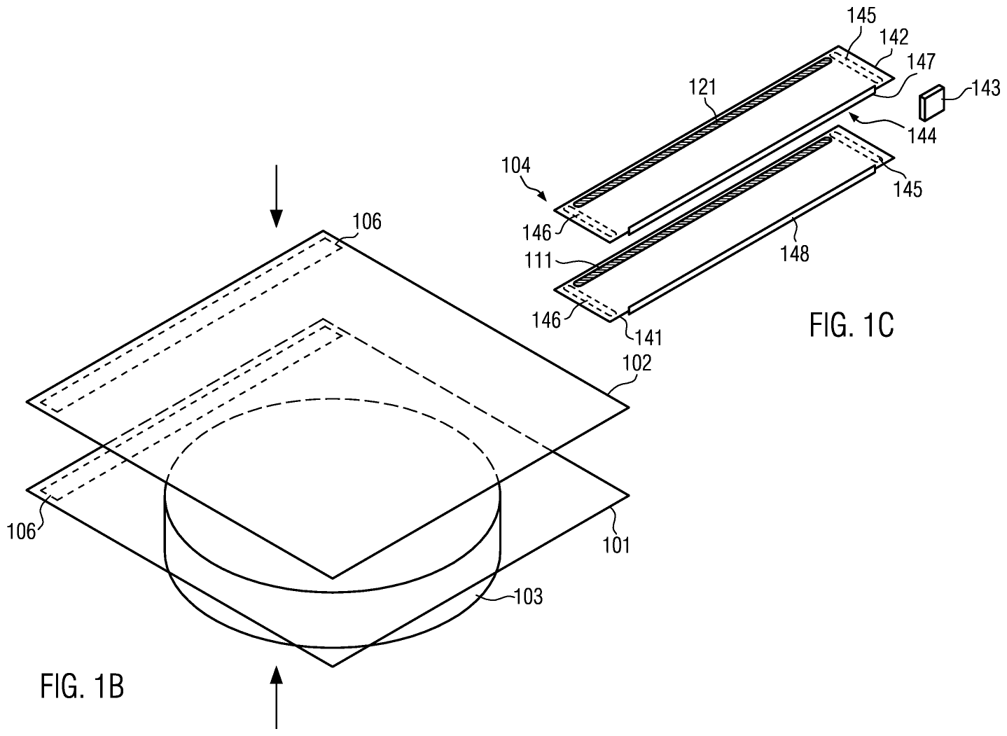

FIG. 1A shows a reclosable package 100 according to one embodiment. The reclosable package 100 comprises a sealed product cavity 103, generally in the form of a trough. The product cavity 103 is formed from a first web 101 and a second web 102. Both or least one of the first web and the second web can be made of thermoformable material like a plastic or other artificial material.

The product cavity is, according to the embodiment depicted, formed in the first web 101 only and the second web 102 has a flat, planar structure. While the first web 101 in which the product cavity is formed may have no further printing on it and may be, for example, almost or completely transparent, the second web 102 may, according to one embodiment, have a printing element 190 which may be, during production, aligned with the product cavity 103 so that the printing element 190 is, for example, always in the center of the product cavity.

Within the product cavity 103, although not shown in the depiction in FIG. 1A, there may be a product like meat or cheese, for example, arranged in a stack of a plurality of cuts.

The first web 101 and the second web 102 together thus at least partially enclose, at least according to this embodiment, the product cavity 103.

In order to secure the product from environmental influence, it can also be provided that the first web and the second web are fused together and, according to one embodiment, there can be provided a first sealing 108 which can be provided by fusing together the first web and the second web by means of heat. This first sealing 108 can extend over at least a portion of the first web and the second web as shown here. The first sealing 108 can either partially surround and/or partially define the inner product cavity 103.

Though the first sealing 108 is depicted here as extending, specifically in the portion 105, around the whole product cavity, this is not necessary, as will be explained further below.

The first web 101 and the second web 102 comprise an overlapping region 106, which may be outside of the product cavity and extend along an edge or border of one side of the first web 101 and the second web 102. In the case where the first web and the second web have a rectangular outer shape, as is depicted in FIG. 1A, the overlapping region 106 may extend at least along a portion of one of the sides of this rectangular outer shape.

According to an embodiment, a zipper element 104 is arranged at least partially within this overlapping region 106 and extends from the overlapping region 106 in a direction away from the product cavity 103 and the first web 101 and the second web 102.

Outside of the overlapping region 106, the zipper element comprises a zipper track 144 and an optional slider 143. The zipper track 144 and the optional slider 143 may be arranged so as to allow for opening and closing the zipper track 144 by moving the slider 143 relative to the zipper track. Thereby, the interior of the reclosable package 100 and, specifically, the product cavity 103, can be reached by a user.

However, the zipper element is not limited to embodiments where a slider 143 is provided. Though it will be referred to in the following to zipper elements that comprise a slider, also realizations of the zipper element without a slider are covered by this description.

As will be explained further below, the zipper element 104 may comprise a third web 141 and a fourth web 142 that, together, form at least part of the zipper element and at least one of them comprises the zipper track 144 where, in some embodiments, the zipper track 144 is provided by zipper track elements arranged at both, the third web 141 and the fourth web 142.

As depicted in FIG. 1A, the zipper element may comprise fused regions 145 and 146 at the borders of the third web 141 and the fourth web 142 where these fused regions 145 and 146 extend from the zipper track 144 or the side of the zipper element 104 at which the zipper track 144 is provided in a direction to the overlapping region 106 and into the overlapping region. Thereby, the borders of the zipper element are sealed and, when the zipper element and the fused regions 145 and 146 extend into the overlapping region, also the product cavity is sealed from the outside.

The third web 141 may be fused to the first web 101 and the fourth web 142 may be fused to the second web 102 so as to achieve a sealing of the product cavity from the environment as long as the zipper element is closed by virtue of the slider 143 being in a position where the zipper track 144 is sealed.

In an embodiment, the first sealing 108 together with the fused border regions 145 and 146 and the zipper track 144 may form the product cavity 103 or at least enclose the product cavity such that it can be sealed shut. In a further embodiment, as depicted, it is possible that an “inner seal” 105 also named “second sealing” is arranged in the overlapping region, specifically between the third web 141 and the fourth web 142. Irrespective of whether or not the zipper track is open or closed, this inner seal, as long as it is not broken when actively opening the package, can seal, together with the first sealing, the product cavity 103.

In general, there may thus be provided two embodiments of the reclosable package. In one embodiment, the product cavity 103 is completely sealed by a sealing applied to the first web 101 and the second web 102. In other embodiments, a sealing of the product cavity is provided partially by a sealing of the first web 101 and the second web 102 and partially by fusing together the third web 141 and the fourth web 142 in the overlapping region of the first web and the second web. Both embodiments hermetically seal the product cavity 103 until the seal is broken by a user.

The FIGS. 1B and 1C depict the first and second web and the zipper element in isolation as would be the case, for example, during manufacture of the reclosable package.

In FIG. 1B, the first web 101 and the second web 102 are shown in close proximity to each other in a state where they are not yet fused.

As is seen here, the second web 102 has a substantially planar surface in this embodiment. While this can be the case, it is not mandatory for other embodiments. Specifically, it can be provided in some embodiments that the product cavity 103 is not only formed in the first web 101 but is formed in both, the first web and the second web so that, for example, the second web 102 may comprise a “product cavity portion” corresponding to that of the product cavity 103 in the first web 101 depicted in FIG. 1B.

The first web 101 and the second web 102 are depicted here as having a rectangular shape. This is, however, only one embodiment. The disclosure is not limited to a specific outer shape of the first web 101 and the second web 102. Specifically, the outer shape of the first web 101 and the second web 102 can also be triangular or can have no edges at all, being for example circular in shape or elliptical.

Also, the product cavity 103 shown here is circular in shape. This is likewise not limiting and only shows one embodiment. For example, depending on the shape and size of the products to be filled in the product cavity 103, the shape of the product cavity may be that of a cylinder as depicted here or may be cubic or may have any other shape.

FIG. 1C depicts the zipper element 104 in isolation from the first and second web.

As is depicted in FIG. 1C, the zipper element comprises the third web 141 and the fourth web 142.

The third web 141 and/or the fourth web 142 may comprise a sealing aid 111 and 121, respectively. This sealing aid may be formed of, for example, polyurethane, or may comprise the same. This can be used in connection with the first web or the second web to ensure that, in a fusing step where the first web and the second web are fused together with the third web and the fourth web, the third web and the fourth web do not fuse together. This can be advantageous as it prevents the third web 141 and the fourth web 142 of unintentionally providing a further sealing.

However, the sealing aids 111 and 121 are not mandatory. In any case, if such sealing aids 111 and 121 are provided, they are arranged at the third web and the fourth web at the position where the third web and the fourth web would be introduced into the overlapping region 106 of the first web and the second web, respectively. The sealing aid 111 would then be arranged on the side of the third web 141 that faces away from the fourth web. Likewise, the sealing aid 121 would be provided on the side of the fourth web 142 that faces away from the third web.

Furthermore, the zipper element 104 comprises a zipper track 144. This zipper track is made up of, usually, two zipper track elements 147 and 148, where one zipper track element 148 is arranged at the third web 141 and one zipper track element 147 is arranged at the fourth web 142. These can work together so as to realize a connection that can be opened and closed, thereby realizing the reclosable characteristic of the reclosable package once assembled. The closing and opening of the zipper track may be achieved with the slider 143 that can be moved along the zipper track in a direction that allows for opening and/or closing the zipper track 144. However, the opening and closing of the zipper track 144 and specifically the zipper track elements 147 and 148 may also be achieved without a slider by either pressing together (for closing) or pulling apart (for opening) the zipper track elements 147 and 148. Generally, the zipper track elements may have interlocking shapes in the form of grooves or patterns so as to allow the zipper track element 147 and the zipper track element 148 to interlock with each other, thereby realizing a sealed closure. In some embodiments, this sealed closure may be gas-tight.

The zipper track and, specifically the zipper track elements can be made of a plastic material. The same holds for the third web and the fourth web and the slider. However, also other materials may be chosen as appropriate. Further, the zipper element may be made of a transparent or nontransparent material depending on the circumstances.

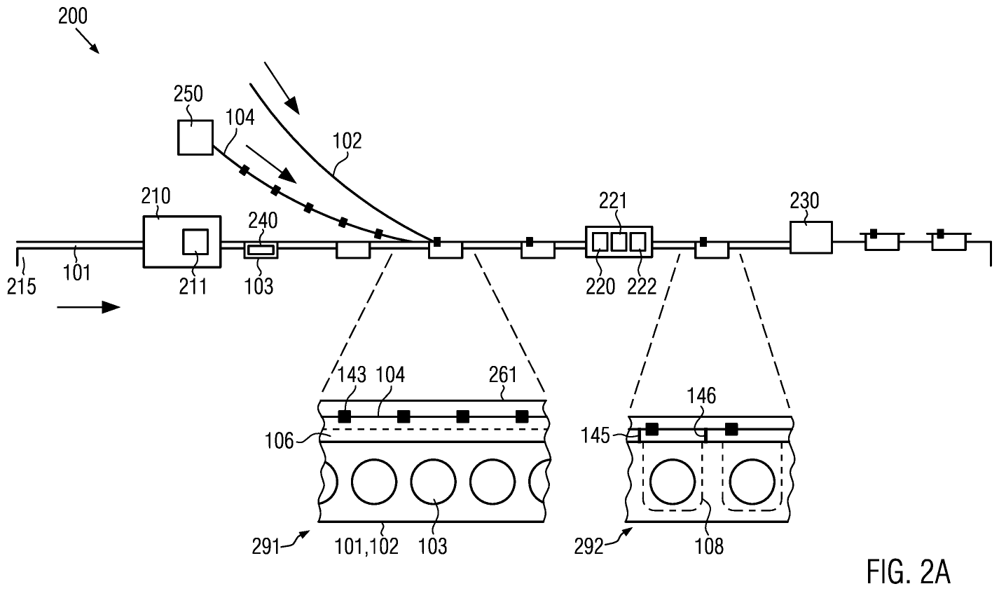

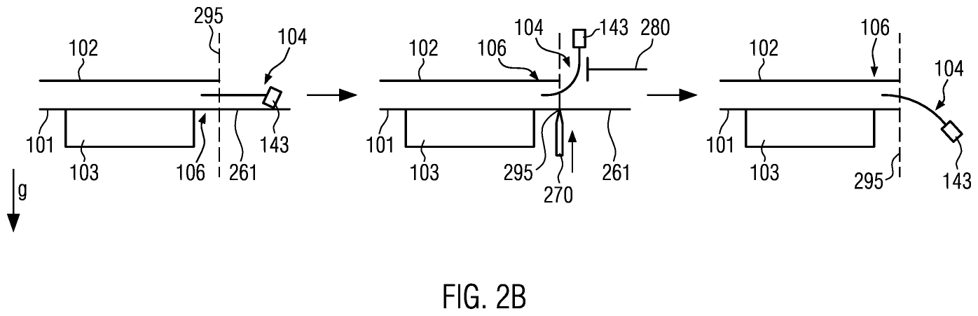

FIG. 2A shows a machine 200 for producing a reclosable package in accordance with an embodiment. Specifically, the reclosable package produced with this machine 200 may be a reclosable package according to FIG. 1 as already explained in more detail above.

The machine 200 may comprise a transport track 215 on which, in a first situation, the first web 101 may be transported. Subsequently, once the zipper element and/or the second web are arranged relative to the first web, the transport track may also be arranged and adapted for registered transport of the first web and the second web. Generally, and specifically in order to realize a registered transport, the transport track 215 can be realized in the form of a chain for transporting the first web and/or the second web.

The machine 200 may further comprise in transport direction of the first web (arrows shown in FIG. 2A) at least a forming station 210. In the embodiment depicted, the forming station 210 is arranged in relation to the first web such that, when the first web is transported through the forming station 210, a product cavity 103 is formed in the first web, for example by thermoforming.

In some embodiments, the product cavity is formed by a product cavity element in the first web and a product cavity element in the second web 102. Though not explicitly shown here in FIG. 2A, the forming station 210 may comprise two parts where a first part forms a product cavity element 103 as depicted in the first web 101 and the second part forms another product cavity element in the second web 102. For simplicity of explanation, however, this is not shown here and the exemplary embodiment of FIG. 2A is an embodiment where the product cavity 103 is realized merely by providing one product cavity element in the first web 101.

Together with the forming station 210 or integrated in the same, a filling station 211 may be provided that is arranged and adapted for placing one or more products 240 within the product cavity 103. Alternatively, the product cavity may be formed in the first web 101 after the products 240 have been placed on the first web 101, so that the product cavity is formed in the first web 101 with the products 240 already in place. The products 240 may, for example, be in the form of slices of meat or cheese. The kind of products is, however, not intended to limit the disclosure and any products may be placed in the product cavity 103.

Furthermore, a zipper supply station 250 may be provided that is able to provide zipper elements 104, for example in the form of a continuous flow of zipper element material that can be later on cut together with the first web and the second web into separate reclosable packages once these are fused together. The zipper supply station 250 may be adapted to provide the zipper element 104 so that it is arranged between the first web 101 and the second web 102 in the overlapping region between the first web and the second web.

Specifically, the zipper element may be provided such that the zipper track as explained with relation to FIG. 1 and the optional slider 143 are arranged outside of the overlapping region 106 of the first web and the second web. This arrangement is shown in the enlarged image 291 and which a top view on the respective position in the machine 200 and specifically of the arrangement of the first web 101, the second web 102 and the zipper element 104 as well as the optional slider 143 is shown. The zipper element may either be provided in a way that the third web 141 and the fourth web 142 are separated except for the region where the slider 143 seals the zipper track 144. In alternative embodiments, the third web 141 and the fourth web 142 may be loosely fused together, as also explained previously, so as to provide a further sealing. In such embodiments, the third web and the fourth web can be provided by a single extrusion. This also makes a further sealing station for establishing a sealing between the third web 141 and the fourth web 142 obsolete.

In this arrangement, it is also depicted that there is an extending region 261 that is formed within at least one of the first web and the second web. On this extending region, in one embodiment, the zipper element 104 and specifically the part of the zipper element that extends beyond the overlapping region and includes the zipper track 144 and the slider 143 may rest.

As is seen in the enlarged image 291, the zipper element 104 is arranged in this embodiment at an outer border of the first web and the second web that is, for example, when seen in the transport direction of the first web, on the left side or the right side of the first web and the second web.

Though not shown here, the machine 200 may be adapted to provide first webs and second webs in which two product cavities can be formed adjacent to each other in a direction perpendicular to the transport direction but in a plane of the first web. In such a case, it is conceivable that the zipper supply station 250 provides, when seen in the transport direction of the first web, a first zipper element on the left side of the first web and a second zipper element on the right side of the first web. Thereby, it is possible to simultaneously provide two adjacent reclosable packages when seen in a direction perpendicular to the transport direction.

The machine may further comprise a first sealing station 220. This may be arranged in transport direction after the point enlarged in the image 291, i.e., after the first web 101, the zipper element 104 and the second web 102 have been arranged relative to each other.

The first sealing station may apply, as is seen in the enlarged image 292, the first sealing 108.

A second sealing station 221 which may be arranged downstream of the first sealing station 220 in the transport direction of the reclosable packages may be provided to realize a sealing or fusing of a portion of the third web 141 and the first web 101 as well as a fusing of a portion of the fourth web 142 and second web 102, respectively. Thereby, the zipper element is connected, in the overlapping region, with the first web and the second web so that the junction between the first web 101 and the third web 141 on the one side and the second web 102 and the fourth web 142 on the other side is sealed shut.

In alternative embodiments, it may be provided that the first sealing station 220 completely seals the product cavity, thereby achieving a sealing between the first web 101 and the second web 102 as well as the second web 102 and the fourth web 142.

The machine may also comprise a third sealing station 222 which provides, at the border regions of the zipper element 104, the sealing materials 145 and 146 or seals the zipper element at these regions which may extend into the overlapping region 106.

Together with the sealing applied by the first sealing station 220 and the second sealing station 221, this achieves, as long as the zipper track is closed, a sealed product cavity which is isolated from environmental influences.

As explained previously, there may also be provided an additional second sealing in the overlapping region where the third web 141 and the fourth web 142 are fused together so as to achieve a sealing of the product cavity from the environment, irrespective of whether the zipper element 104 is closed at the zipper track or not. This additional sealing can be applied, for example, by the first sealing station 220 simultaneously with applying the first sealing 108.

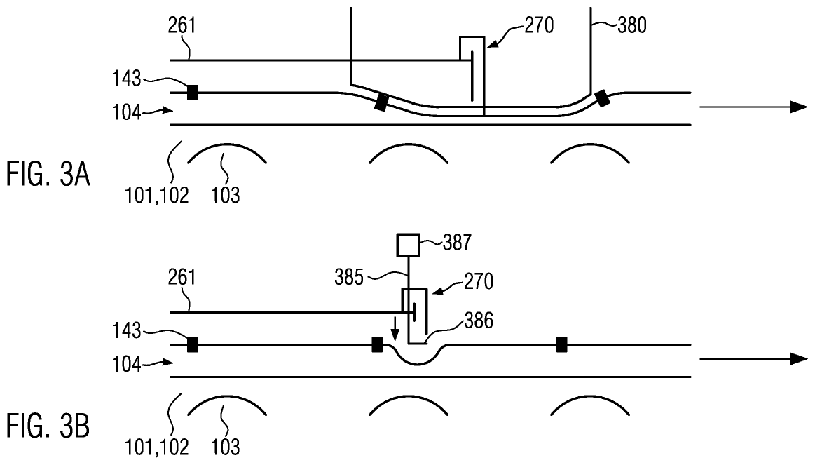

Downstream of the sealing stations, in at least in one embodiment, there is a lifting element which will be explained with respect to FIG. 3 which lifts the zipper element from the extending portion 261 and cuts away the extending portion 261 so as to obtain the overlapping region 106 of the first web 101 and the second web 102 and allow the zipper track 144 along with the slider 143 to be arranged outside of the overlapping region and the first web and the second web.

Furthermore, downstream of the sealing stations and downstream the lifting element, there may be arranged a separating station 230 that separates the continuous flow of web material into separated, sealed, closed and filled reclosable packages.

In the description above and as explained in FIG. 2A, the fusing of the webs (i.e., first and third as well as second and fourth and first and second) takes place after all webs have been arranged relative to each other in the sealing stations 220 to 222.

In one embodiment, however, it can also be provided that a first sealing or fusing step is carried out before the second web 102 is placed in relation to the first web 101. Specifically, in one embodiment, the first sealing station 220 may be provided to establish a sealing between the first web and the third web and may be arranged upstream of the point where the second web 102 is arranged in relation to the first web 101 but downstream of the point where the zipper element 104 is placed on or in relation to the first web. Thereby, a sealing between the first web and the zipper element is achieved before the second web 102 is placed in relation to the first web 101 and the zipper element 104.

Then, after the point where the second web 102 is placed on the first web 101 and the already placed zipper element 104, a further sealing step may take place (for example by sealing station 221) where the second web 102 is fused with the fourth web 142. Additionally, in some embodiments, the third web 141 and the fourth web 142 and/or the zipper track elements 147 and 148 may be flattened at this point. This can be advantageous in order to achieve proper closing and fusing of the webs. Additionally (or in the station 222), a fusing of the first web and the second web 102 can be achieved. For these purposes, the sealing stations 221 and 222 may be used as depicted in FIG. 2A. In this embodiment, the sealing stations would, in other words, be “split” into a first part arranged as described above so as to fuse the first web 101 and the third web 141 and a second part arranged as described above so as to fuse the second web 102 and the fourth web 142. Moreover, for example in the sealing station 221 or 222, a sealing in the regions 145 and 146 may take place as already explained above.

In all embodiments described above, the second web 102 may not extend beyond the intended overlapping region of the first web 101 and the second web 102. Thereby, a definite border for the overlapping region may already be provided by the second web 102 itself. Furthermore, cutting away a portion of the second web 102 may not be necessary.

Irrespective of where this sealing and fusing takes place, it may be provided that a pressing means (for example as part of the sealing stations) presses together the third web 141 and the fourth web 142 so as to flatten the zipper element in order to prevent, for example distortions during sealing steps.

FIG. 2B shows the process of cutting away the extending region 261 of the first web in one example. While in the depiction of FIG. 2B, the first web 201 comprises the extending region 261, it can also be provided that the second web 102 comprises the extending region 261. This particularly depends on the arrangement of the first web 101, the zipper element 104 and the second web 102 relative to each other and with respect to the direction of gravity g as shown in FIG. 2B.

The extending region 261 aids in arranging the zipper element 104 with respect to the first web 101 and the second web 102 as long as these are not yet fused together. This is because as long as these webs are not fused together with the zipper element, the first web, the second web and the zipper element are moveable relative to each other. In order to prevent the zipper element from misalignments, the extending region 261 provides a support for the zipper element that otherwise would extend outside the first web and the second web and the overlapping region and would potentially drop off the arrangement.

In the left-most depiction in FIG. 2B, the zipper element 104 together with the slider 143 rests on the first web 101 and specifically the extending region 261 at least with respect to the slider 143. More particularly, in one embodiment, it may be provided that the extending region 261 has an extension seen from the end 295 of the overlapping region 106 that is at least as long as the portion of the zipper element 104 extending outside of the end 295 of the overlapping region including the slider 243. The extending region 261 may extend even further from the overlapping region 106 than the zipper element 104 including the slider 143. For example, the extending region 261 may extend, from the border of the overlapping region 106, 0.5 cm or 1.0 cm further than the zipper element 104 including the slider 143.

In the next step shown in FIG. 2B, a lifting element 280 lifts the zipper element 104 together with the slider away from the extending region 261. In this lifted position, a cutting tool or cutting element 270 can be moved towards the extending region 261 to cut away the extending region at the position where the overlapping region is to end 295. The portion of the first web 101, in this embodiment, that forms the extending region 261 extending beyond the end of the overlapping region 106 is thus cut away and leaves the overlapping region 106 untouched.

The lifting element 280 can then be moved away from the zipper element so that, in the right-most arrangement depicted in FIG. 2B, the zipper element 104 and the slider 143 now extend over the end 295 of the overlapping region 106 and can be freely moved.

FIGS. 3A and 3B depict exemplary embodiments of the cutting tool and the lifting element.

In the arrangement of FIG. 3A, the flow of the first web 101 with the product cavity 103 and the second web 102 together with the zipper element 104 and the slider 143 is shown. The movement follows the arrow depicted in FIG. 3A.

In the embodiment of FIG. 3A, the lifting element is realized as a stationary guide 380. This stationary guide does not move and, consequently, in the flow of the webs, these pass the stationary guide 380. The stationary guide extends towards the product cavity 103 and results in a lifting of the slider 143 and the zipper element 104 away from the extending portion 261, as this was explained in FIG. 2B. The extending portion 261 can then be cut away with a corresponding cutting tool 270 which is depicted here only schematically so that the extending region 261 is no longer present after the webs passed the cutting tool 270.

The stationary guide 280 can have arbitrary shape. In one embodiment, the stationary guide 280 is not provided in the form of a stop but has a region that continuously extends towards the product cavity 103 or, more generally, the center of the transport track depicted in FIG. 2A so as to guide the zipper element together with the slider continuously towards the lifted position as depicted for example in the middle arrangement of FIG. 2B. Thereby, damage or distortions of the zipper element and the reclosable package may be avoided.

In FIG. 3B, the lifting element is schematically depicted as a plow mechanism 385. This plow mechanism comprises a moveable plow element 386 that can be moved towards and away from the product cavities (or the center of the transport track). This is shown with the respective arrows pointing towards the product cavities 103.

Additionally, the plow mechanism may comprise an actuator 387 that is adapted to move the moveable plow element 386. The actuator 287 may, for example, be embodied in the form of an electric motor or the like. The actuator may be controlled so that its movement towards and away from the transport track is synchronized with the movement speed of the packages in the flow of packages. Specifically, it may be provided that the speed with which the plow element 386 is moved towards the transport track and away from the same is higher the higher the movement speed of the packages is.

This arrangement of FIG. 3B allows for specifically lifting only those portions of the zipper element under which a cutting-away of the extending portion 261 is indeed necessary.

As the reclosable packages are separated, as was explained with respect to FIG. 2A, after the manufacture, the extending portions 261 between separate reclosable packages do not need to be cut away and, therefore, in these portions, the zipper element would also not need to be lifted.

### List of Further Embodiments

1. A reclosable package, comprising:
a first web thermoformed into a trough shape and a second web, the first web and the second web enclosing a product cavity;
a first sealing extending over at least a portion of the first web and the second web and connecting the first web and the second web, the first sealing at least partially defining a periphery of the product cavity;
a zipper element, the zipper element comprising a third web, a fourth web, a zipper track and an optional slider for opening and closing the zipper track;
the zipper track and the optional slider being arranged at an outer border of the third web and the fourth web;
the zipper element extending from an overlapping region of the first web and the second web, wherein the zipper track and the optional slider are arranged outside of the overlapping region;
wherein, in the overlapping region, the third web is fused with the first web and the fourth web is fused with the second web.
2. The reclosable package of embodiment 1, wherein the third web and the fourth web have a polyethylene coating on their outer surface at least in the overlapping region.
3. The reclosable package of embodiment 1 or 2, wherein the third web and the fourth web are fused together at border regions of the third web and the fourth web extending from the zipper track to the overlapping region.
4. The reclosable package of embodiment 3, wherein the border regions, the first sealing and the zipper element define the periphery of the product cavity.
5. The reclosable package of any of the embodiments 1 to 4, further comprising a second sealing between the third web and the fourth web in the overlapping region, the first sealing and the second sealing together defining the periphery of the product cavity.
6. The reclosable package of any of the embodiments 1 to 5, wherein the zipper track and the slider are arranged outside of the first web and the second web and outside of the overlapping region.
7. A method of manufacturing a reclosable package, comprising the steps of:
providing a first web and a second web;
forming a product cavity by the first web and the second web;
arranging, between the first web and the second web, a zipper element, the zipper element comprising a third web, a fourth web, a zipper track and an optional slider for opening and closing the zipper track, the zipper track and the optional slider being arranged at an outer border of the third web and the fourth web; wherein the zipper element is arranged between the first web and the second web so as to extend from an overlapping region of the first web and the second web to a region outside of the first web and the second web, wherein the zipper track and the optional slider are arranged outside of the overlapping region;
forming a first sealing by fusing together at least a portion of the first web and a portion of the second web;
fusing together, in the overlapping region, a portion of the third web and the first web and a portion of the fourth web and the second web.
8. The method according to embodiment 7, wherein forming the product cavity comprises forming a product cavity in the first web by thermoforming.
9. The method of embodiment 7 or 8, wherein one of the first web and the second web comprises an extending region that extends, in the direction from the overlapping region to the zipper track, beyond the position of the zipper track and the optional slider;
wherein the method further comprises lifting the zipper element by lifting the optional slider and/or the zipper track away from the extending region;
cutting the extending region away while the zipper element is lifted.
10. The method of any of the embodiments 7 to 9, wherein, before forming the first sealing and after forming the product cavity, the method comprises placing a product in the product cavity.
11. The method of any of the embodiments 7 to 10, wherein the first web and the second web and the zipper element are provided as endless elements and are transported on at least one chain, and wherein at least one of the first web and the second web comprises a print element, and the first web and the second web are registered relative to each other and the product cavity depending on the position of the print element.
12. A machine for producing a reclosable package, the machine comprising a transport track for registered transport of a first web and a second web, a forming station for forming a product cavity in the first web and the second web, a zipper supply station for providing, in an overlapping region of the first web and the second web, a zipper element, the zipper element comprising a third web, a fourth web, a zipper track and an optional slider for opening and closing the zipper track, the zipper track and the optional slider being arranged by the zipper supply station at an outer border of the third web and the fourth web; wherein the zipper element is arranged so as to extend from an overlapping region of the first web and the second web to a region outside of the first web and the second web, wherein the zipper track and the optional slider are arranged outside of the overlapping region;
wherein one of the first web and the second web comprises an extending region that extends, in the direction from the overlapping region to the zipper track, beyond the position of the zipper track and the optional slider;
the machine comprising a lifting element for lifting the zipper element by lifting the optional slider and/or the zipper track away from the extending region, a cutter element for cutting away the extending region while the zipper element is lifted;
the machine comprising a first sealing station for sealing the first web and the second web so as to form a first sealing defining a periphery of the product cavity and a second sealing station for sealing a portion of the third web and the first web and a portion of the fourth web and the second web in the overlapping region.
13. The machine of embodiment 12, further comprising a third sealing station for sealing the third web and the fourth web at the border regions of the third web and the fourth web, the border regions extending from the zipper track to the overlapping region.
14. The machine of embodiment 12 or 13, wherein the machine comprises at least one chain for transporting the first web and/or the second web.
15. The machine of any of the embodiments 12 to 14, wherein the lifting element is arranged alongside the chain and is adapted for moving the optional slider and/or the zipper track in the direction of a center line of the chain, thereby lifting the zipper element.
16. The machine of any of the embodiments 12 to 15, wherein the lifting element is or comprises a plow mechanism.
17. The machine according to embodiment 16, wherein the plow mechanism is movably arranged.
18. The machine according to any of the embodiments 12 to 15, wherein the lifting element is or comprises a stationary guide for guiding a movement of the zipper track and/or the optional slider, thereby lifting the zipper element.

What is claimed is:

1. A reclosable package, comprising:
a first web thermoformed into a trough shape and a second web, the first web and the second web enclosing a product cavity;
a first sealing extending over at least a portion of the first web and at least a portion of the second web and connecting the first web and the second web, the first sealing at least partially defining a periphery of the product cavity; and
a zipper element comprising a third web, a fourth web and a zipper track, wherein the zipper track is arranged at an outer border of the third web and the fourth web, the zipper element extends from an overlapping region of the first web and the second web, the zipper track is arranged outside of the overlapping region, and, in the overlapping region, the third web is fused with the first web and the fourth web is fused with the second web.

2. The reclosable package of claim 1, wherein the third web and the fourth web each have a polyethylene coating at least in the overlapping region.

3. The reclosable package of claim 1, wherein the third web and the fourth web are fused together at border regions of the third web and the fourth web extending from the zipper track to the overlapping region.

4. The reclosable package of claim 3, wherein the border regions, the first sealing and the zipper element define the periphery of the product cavity.

5. The reclosable package of claim 1, further comprising a second sealing between the third web and the fourth web in the overlapping region, the first sealing and the second sealing together defining the periphery of the product cavity.

6. The reclosable package of claim 1, wherein the zipper track is arranged outside of the first web and the second web.

7. The reclosable package of claim 1, wherein the zipper element comprises a slider for opening and closing the zipper track, and wherein the slider is arranged outside of the overlapping region.

8. A method of manufacturing a reclosable package, comprising:
providing a first web and a second web;
forming a product cavity by the first web and the second web;
arranging, between the first web and the second web, a zipper element, the zipper element comprising a third web, a fourth web and a zipper track, the zipper track being arranged at an outer border of the third web and the fourth web, wherein the zipper element is arranged between the first web and the second web so as to extend from an overlapping region of the first web and the second web to a region outside of the overlapping region, and wherein the zipper track is arranged outside of the overlapping region;
forming a first sealing by fusing together at least a portion of the first web and at least a portion of the second web; and
fusing together, in the overlapping region, a portion of each of the third web and the first web and a portion of each of the fourth web and the second web.

9. The method according to claim 8, wherein forming the product cavity comprises forming a product cavity portion in the first web by thermoforming.

10. The method of claim 8, wherein one of the first web and the second web comprises an extending region that extends, in a direction from the overlapping region to the zipper track, beyond a position of the zipper track;
wherein the method further comprises lifting the zipper element away from the extending region; and
cutting the extending region away while the zipper element is lifted.

11. The method of claim 8, wherein, before forming the first sealing and after forming the product cavity, the method comprises placing a product in the product cavity.

12. The method of claim 8, wherein the first web and the second web and the zipper element are provided as endless elements and are transported on at least one chain, and wherein at least one of the first web and the second web comprises a print element, and the first web and the second web are registered relative to each other and the product cavity depending on the position of the print element.

13. The method of claim 8, wherein the zipper element comprises a slider for opening and closing the zipper track, and wherein the slider is arranged outside of the overlapping region when the zipper element is arranged between the first web and the second web.

14. A machine for producing a reclosable package, the machine comprising:
a transport track for registered transport of a first web and a second web;
a forming station for forming a product cavity in the first web or the second web;
a zipper supply station for providing, in an overlapping region of the first web and the second web, a zipper element, the zipper element comprising a third web, a fourth web and a zipper track, wherein the zipper supply station is configured to arrange the zipper element so as to extend from the overlapping region of the first web and the second web to a region outside of the overlapping region, and so that the zipper track is arranged at an outer border of the third web and the fourth web and outside of the overlapping region, and wherein one of the first web and the second web comprises an extending region that extends, in a direction from the overlapping region to the zipper track, beyond a position of the zipper track when the zipper element is arranged by the zipper supply station;
a lifting element for lifting the zipper element away from the extending region;
a cutter element for cutting away the extending region while the zipper element is lifted;
a first sealing station for sealing the first web and the second web so as to form a first sealing defining at least a portion of a periphery of the product cavity; and
a second sealing station for sealing a portion of each of the third web and the first web and a portion of each of the fourth web and the second web in the overlapping region.

15. The machine of claim 14, further comprising a third sealing station for sealing the third web and the fourth web at border regions of the third web and the fourth web, the border regions extending from the zipper track to the overlapping region.

16. The machine of claim 14, wherein the machine comprises at least one chain for transporting the first web and/or the second web.

17. The machine of claim 16, wherein the lifting element is arranged alongside the at least one chain and is configured to move the zipper track in a direction of a center line of the chain, thereby lifting the zipper element.

18. The machine of claim 14, wherein the lifting element comprises a plow mechanism.

19. The machine according to claim 18, wherein the plow mechanism is movably arranged.

20. The machine according to claim 14, wherein the lifting element comprises a stationary guide for guiding a movement of the zipper track, thereby lifting the zipper element.

21. The machine according to claim 14, wherein the zipper element includes a slider for opening and closing the zipper track, and wherein the zipper supply station is configured to arrange the zipper element so that the slider is outside of the overlapping region.
